(19) United States
(12) Patent Application Publication
(10) Pub. No.: US 2025/0360944 A1
(43) Pub. Date: Nov. 27, 2025

(54) ANALYSIS UNIT, VEHICLE AND METHOD FOR ANALYZING A MANEUVERING OPTION

(71) Applicant: HELLA GMBH & CO. KGAA, Lippstadt (DE)

(72) Inventors: Richard Giese, Berlin (DE); Dennis Kreber, Frankfurt (DE); Juergen Mayntz, Berlin (DE); Florian Reifschneider, Frankfurt (DE); Kay Talmi, Berlin (DE)

(21) Appl. No.: 19/297,232

(22) Filed: Aug. 12, 2025

Related U.S. Application Data
(63) Continuation of application No. PCT/EP2024/052443, filed on Feb. 1, 2024.

(30) Foreign Application Priority Data
Feb. 13, 2023 (DE) 102023103368.9

(51) Int. Cl. B60W 60/00

(52) U.S. Cl. CPC B60W 60/0011; B60W 2555/60; B60W 2556/50

(57) ABSTRACT

The invention relates to an analysis unit for a vehicle, to a method for analyzing maneuvering options of a vehicle, and to a vehicle having an analysis unit of this kind. The analysis unit includes: an input interface, in particular for a position of the vehicle; an output interface for an output signal; and a decision logic for analyzing at least one maneuvering option, wherein the analysis of the maneuvering option in question is performed on the basis of the position of the vehicle, and wherein an analysis result can be provided as an output signal to a control unit or a BUS system of the vehicle.

### CROSS-REFERENCE TO RELATED APPLICATIONS

The present application is a continuation of PCT/EP2024/052443, filed Feb. 1, 2024, which claims the benefit of German Patent Application No. 10-2023-103-368.9, filed Feb. 13, 2023, the disclosures of which are incorporated by reference in their entirety.

### FIELD OF THE INVENTION

The invention relates to an analysis unit, a vehicle, and a method for analyzing a maneuvering option.

### BACKGROUND OF THE INVENTION

Traffic rules are becoming increasingly complex today. In federal states in particular, traffic regulations may differ from one region to another. In addition, the development of autonomous driving continues to progress. To avoid accidents, especially with self-driving vehicles, traffic rules must be observed. However, this is not always easy, especially as traffic rules may change over time. It is, therefore, an object of the invention to provide a unit by means of which a simple analysis of possible maneuvering options of a vehicle is possible.

### SUMMARY OF THE INVENTION

The foregoing object is achieved by an analysis unit, a vehicle with such an analysis unit, a method, and a computer program product according to embodiments disclosed herein. Further advantageous embodiments and further developments are also set forth herein. The analysis unit is designed for use in a vehicle. The analysis unit comprises an input interface for a position and for providing at least one maneuvering option, as well as an output interface for an output signal, in particular for providing an analysis result, and further comprises a decision logic, wherein the decision logic is provided for analyzing at least one maneuvering option, wherein the analysis of the respective maneuvering option is provided on the basis of the position of the vehicle, wherein an analysis result can be provided as an output signal to a control unit or a BUS system of the vehicle.

Advantageously, the respective possible maneuvering option can be determined based on the respective position of the vehicle.

A position of the vehicle may be understood as the type of traffic route on which the vehicle is located, whereby a traffic route may be a country road, a highway, a freeway, an inner-city street or a parking lot. The traffic route is advantageously determined by the position of the vehicle.

The analysis unit is preferably designed as a computer program product. Advantageously, the input interface and the output interface are designed as a software interface by means of which the computer program product can record or share the position, the respective maneuvering option, and/or the analysis result with other software modules or interfaces.

The analysis unit is advantageously designed as a module to supplement a vehicle control system or to be installed on a vehicle control system.

The module or the computer program product is advantageously designed for installation on a computing unit, in particular on a control unit for a vehicle. The advantage is that it can be loaded into the memory of the computing unit and can be executed with the aid of a processor.

The analysis unit may be implemented as a computing unit with a memory, a processor, and at least one input interface and one output interface. Preferably, the analysis unit is implemented as a module with a corresponding computer program product. The analysis unit is advantageously implemented as a module in a vehicle control system.

The input interface or the output interface is each advantageously designed as a CAN bus, Ethernet, LIN BUS interface, or as other network interface. Alternatively, the input interface or the output interface may be implemented as a software interface.

The respective software interface is advantageously suitable and designed to receive a signal from a BUS system or to provide it to the BUS system.

The maneuvering option of the input interface is provided as an advantage. The advantage is that the position of the vehicle and the respective maneuvering option is provided to the decision logic.

The decision logic advantageously comprises a plurality of inputs for the respective maneuvering option and an output for the analysis result. The analysis is preferably binary, for example “Allowed” or “Yes” (Y), and “Prohibited” or “No” (N).

Advantageously, the analysis unit, in particular, the decision logic, provides the result of an analysis as an analysis result in binary form (“Allowed”, Y) or in the case of a negative analysis (“Prohibited”, N). The analysis result can be advantageously provided as a binary signal to the output interface by the respective output signal.

The position of the vehicle is preferably determined continuously by the position sensor and advantageously provided to the analysis unit. Alternatively, the position of the vehicle can be determined separately for each individual analysis. It is advantageous to determine the position using a position sensor that is already present in the vehicle.

In a simple case, a possible maneuvering option may refer to increasing or reducing the speed of the vehicle, as well as “steering to the right” or “steering to the left” of the vehicle.

There may also be other maneuvering options: an overtaking maneuver; parking on the right/left side of the roadway; following the course of the road (straight ahead); a left turn; a right turn; a lane change to the right/left lane; crossing an intersection; and/or a stopping maneuver.

The analysis of the respective maneuvering option is advantageously based on the respective permissibility in accordance with the applicable traffic regulations. The structure of the decision logic is advantageously based on the traffic rules. The structure can be changed, for example in the event of changing traffic rules. The decision logic is advantageously designed in such a way that the analysis can be carried out on the basis of the traffic rules.

In Germany, for example, the traffic rules are set out in the Road Traffic Regulations (StVO) or the Road Traffic Act (StVG).

Advantageously, the analysis is made according to whether the respective maneuvering option is permissible (“allowed”, positive) or not permissible (“prohibited”, negative) in accordance with the currently valid traffic rules.

Advantageously, only the possible and/or requested maneuvering options of the vehicle are analyzed. This means that only a reduced number of maneuvering options can be analyzed by the decision logic.

The decision logic can take the form of a neural network, a decision tree, Boolean decision logic, or any other structure, e.g. a decision ontology. The decision logic is advantageously deterministic. With advantage, the decision logic can perform an analysis of a plurality of maneuvering options in a simple manner.

The analysis unit can provide the analysis result to a vehicle control system, which can make a decision regarding the maneuvering option based on the analysis result. Alternatively, the analysis result may also be displayed to the driver, who may or may not execute the respective maneuvering option based on the analysis result.

Accordingly, the invention described herein enables the decision logic, and thus the analysis unit, to be formed simply and with correspondingly low computational effort.

In an advantageous embodiment of the invention, a position sensor, in particular, a GPS sensor, is provided for supplying the position.

Alternatively or additionally, the position may be determined based on the use of a mobile communication network.

Advantageously, a vehicle already includes a GPS sensor to detect the position of the vehicle, such as for a navigation system. The use of a GPS sensor is advantageous, because the position can be determined particularly easily and accurately.

In a further advantageous embodiment of the invention, the decision logic is based on Boolean decision logic.

Boolean decision logic comprises a plurality of logic modules and is therefore well suited for the quick and simple analysis of a plurality of input signals into an output signal. Advantageously, the maneuvering options can be represented as binary code. The analysis can also be displayed as a binary code (Yes, No/0, 1/or Y, N).

Advantageously, the respective maneuvering option can be represented in a binary code as follows (simplified here for an overtaking maneuver):
1. Increase speed=Yes;
2. Reduce speed=No,
3. Turn right=No;
4. Lane change to the left=Yes

The binary code, which is provided to the decision logic, may advantageously be formed according to (Yes, No, No, Yes, . . . ) or (1, 0, 0, 1, . . . ). Thus, the following assignment is made using the decision logic by way of example: (Position, 0, 0, 1, 0, . . . )→Yes

The respective logic module is advantageously designed as a software module. The decision logic is advantageously designed as a software module. It is advantageous that the decision logic can be changed so that the decision logic can be adapted to changing traffic rules. The decision logic can be modified, in particular, updated, via the BUS system.

Boolean decision logic enables a particularly rapid analysis.

In a further advantageous embodiment of the invention, only one sub-area of the decision logic is activated in each case, with the sub-area being selected in each case on the basis of the position of the vehicle. The scope or functionality of the decision logic can be restricted. It is advantageous if the restriction is limited in time and/or depends on the position of the vehicle.

The advantage is that a large part of the decision logic is not relevant for most decisions. For example, for a position of the vehicle on a highway or a country road, the question of parking is generally not relevant. Since an analysis of such a maneuvering option is not to be expected, only the relevant part of the decision logic may be activated.

By using only one part of the decision logic, analyses can be made even faster and simpler.

In a further advantageous embodiment of the invention, the selection of the respective sub-area of the decision logic takes place in at least a first stage and a second stage.

In the first stage, the decision logic is advantageously restricted in such a way that only those aspects of the decision logic that are relevant to the position of the vehicle require analysis. For example, on a highway (position of the vehicle=highway) not all traffic rules that apply in urban areas are relevant. Accordingly, the decision logic can be reduced in its maneuvering options to be analyzed and/or simplified in its structure according to the position of the vehicle. Depending on the position of the vehicle, only one sub-area of the decision logic is advantageously active or relevant at any one time.

In a second stage, the decision logic can be further reduced to a simplified decision logic based on the vehicle's recorded environment. For example, if a blocked lane is detected and the blockage is indicated by an obstacle, a lane change to the blocked lane must be disregarded. Accordingly, the scope of the decision logic can be further reduced.

The same may apply if dense fog is detected, because a maximum speed on a highway may not be relevant, as the safe driving speed of the vehicle is usually significantly lower.

By reducing or restricting the scope of the decision logic, a decision can advantageously be reached more easily and quickly and/or with reduced computational capacity.

In a further advantageous embodiment of the invention, a reduced number of maneuvering options is provided for analysis according to the position of the vehicle.

By reducing the maneuvering options, the required computational capacity can advantageously be reduced and/or the time for the analysis can be reduced. In addition, the decision logic can be less complex from the outset, and thus a software-based solution of the decision logic can be operated with reduced memory requirements.

In a further advantageous embodiment of the invention, a reduction of the maneuvering options based on an environment of the vehicle is provided.

The environment of the vehicle takes into account, for example, obstacles, other road users in the vicinity, as well as traffic signs, traffic lights, or barriers blocking individual traffic sections.

The environment can be made available to the analysis unit with the help of a traffic guidance system. The surroundings are also advantageously detected by an environment sensor. An environment sensor is advantageously designed as a radar sensor, a LIDAR sensor, or a camera. The environment detected by the environment sensor is advantageously provided by the analysis unit.

It is advantageous to decide whether a maneuvering option is possible at all based on the environment of the vehicle. In such a case, it is advantageous to provide the possible maneuvering options to the decision logic, in particular, to the sub-area of the decision logic.

The decision logic may be reduced in its function if the decision logic is only provided with the maneuvering options for analysis that appear possible at all due to the vehicle's environment. In this case, only a small sub-area of the decision logic needs to be active.

This means that more memory can be saved for the sub-area of the decision logic.

In a further advantageous embodiment of the invention, an analysis of the respective maneuvering option is provided in real time.

Real-time analysis is advantageously defined as a period of time after which an output signal is available once the respective maneuvering option has been provided. An example of such a time span is 0.1 to 5 microseconds.

The presence of an output signal in real time means that a vehicle control system can also control the vehicle in real time. Such an evaluation unit can therefore be used for autonomous vehicles.

The vehicle comprises a position sensor, a control unit and/or a BUS system, and an analysis unit as described above, wherein the position sensor is provided for determining the position of the vehicle, and the analysis unit is designed and provided for analyzing maneuvering options.

The vehicle is advantageously designed as an automobile or as a rail vehicle. Advantageously, the vehicle is designed as a self-driving automobile or autonomous vehicle, so that the automobile can drive from a first position to a second position without a driver without the need for driver assistance.

An autonomous vehicle advantageously provides the respective maneuvering option to the analysis unit with the help of its vehicle control system.

It is advantageous that the respective maneuvering option is provided via the vehicle's bus system to the input interface of the analysis unit. The maneuvering options to be analyzed in each case may be provided by the vehicle control system of a self-driving vehicle. The respective output signal can be made available again to the vehicle control system of the self-driving vehicle.

In the case of a maneuvering option for a non-autonomous vehicle, the respective maneuvering option can be provided by analyzing the driving behavior of a vehicle driver. For example, a planned lane change can be indicated by pressing the corresponding turn signal, or by pressing the accelerator or brake pedal. A movement monitoring system for the driver (changing the driver's line of vision) can also suggest a maneuvering option. The driver thus provides the respective maneuvering option.

Such an analysis of the driver's behavior can lead to the provision of at least one maneuvering option to the analysis unit.

Advantageously, a negative analysis result leads to the provision of the respectively planned or analyzed-with-a-negative-result maneuver to the driver as a (warning) signal. A positive analysis result advantageously does not trigger any signal.

Alternatively, a signal, e.g., a green light signal, can also be displayed to the driver in the event of a positive evaluation result.

Such a signal can include an acoustic signal, a light signal, and/or a slight intervention in the steering/braking system, or in a delayed acceleration.

Advantageously, such a signal is displayed to the driver immediately when an output signal is provided by the analysis unit.

In the case of a self-driving vehicle, the planned maneuvering option may be omitted. For this purpose, the negative analysis result is provided to the vehicle control system. The vehicle control system may then refrain from executing the maneuvering option.

Advantageously, the vehicle comprises at least one driver assistance application (ADAS SYSTEM), such as a distance-keeping assist, a lane-keeping assist, and/or a brake assist. This driver assistance application is generally used to detect the environment. The environment, in particular the position of other road users and obstacles, is advantageously provided to the analysis unit as environment.

The method is used to analyze at least one maneuvering option of a vehicle, wherein the vehicle comprises an analysis unit, in particular an analysis unit as described above. The method comprises the following steps: determining a position of the vehicle; providing the position to the analysis unit; provision of respective maneuvering options, in particular based on the respective position of the vehicle; analysis of the respective maneuvering options; and provision of the analysis as an output signal, wherein the analysis unit carries out the analysis depending on the position of the vehicle on the basis of a decision logic, wherein the decision logic is based on traffic rules which are valid at the respective position of the vehicle.

The decision logic is advantageously based on the traffic rules which are relevant for the respective position of the vehicle, in that the prerequisites and the legal consequences (prohibited, permitted) are formed as input variables or output variables. The decision logic is advantageously designed according to the traffic rules.

The traffic rules may exist as a decision tree, as Boolean decision logic, as a neural network, or as an ontology in the decision logic. The position of the vehicle is advantageously determined by a position sensor and provided to the analysis unit, and/or the analysis unit.

In an autonomous vehicle, the respective maneuvering option can be provided by the vehicle control system, whereby the analysis of the respective maneuvering option provided is carried out with the aid of the analysis unit, and the output signal is (again) provided to the vehicle control system.

The method enables a particularly simple and quick analysis of the respective maneuvering options, in other words, the determination of: Permitted (Yes or Y) or Prohibited (No or N).

In a further advantageous embodiment of the invention, the at least one maneuvering option or a reduced number of maneuvering options can be determined, wherein the analysis of the respective maneuvering possibilities takes place on the basis of a respective sub-area of the decision logic, wherein the respective sub-area of the decision logic is limited to the analysis of the respectively determined or provided maneuvering options.

The sub-area of the decision logic results from the relevant/possible maneuvering options. For example, the maneuvering options “parking on the right-hand side” or “increasing speed from 60 km/h to 80 km/h” are generally not analyzed on a highway, as these are either generally permitted or generally prohibited on most sections of a highway. Accordingly, the decision logic can be reduced to a corresponding sub-area.

In a further advantageous embodiment of the invention, the analysis is based on a previously determined sub-area of the traffic rules, whereby the respective sub-area of the traffic rules can be determined on the basis of the respective position of the vehicle.

For example, a speed limit may not be provided for in some areas of a German highway, and therefore an analysis of the maneuvering option “increasing the speed” would in any case be analyses as “permitted” (Yes or Y).

The sub-area of the relevant part of the traffic rules corresponds advantageously to the sub-area of the decision logic that is based on the valid traffic rules.

By reducing the decision logic to the sub-area, a faster decision can advantageously be made. Reducing the decision logic to a sub-area of the decision logic also requires less memory, insofar as the decision logic is designed as a software module.

In a further advantageous embodiment of the invention, an environment sensor detects the environment of the vehicle and provides the environment to the analysis unit, wherein the respective maneuvering options can be determined on the basis of the environment.

An environment sensor is designed as a radar sensor, LIDAR sensor, ultrasonic or camera sensor. The environment includes the possibility of where the vehicle can be maneuvered without colliding with obstacles or other road users.

Advantageously, a reduced number of decision options is provided to the decision logic on the basis of the environment. For example, in the event of a (planned or intended) lane change of the vehicle in the presence of another vehicle or a blocked lane, no analysis by the decision logic is required.

In a further advantageous embodiment of the invention, an environment sensor detects the environment of the vehicle and provides the environment to the analysis unit, wherein the decision logic, in particular the defined sub-area of the decision logic, can be determined on the basis of the environment.

The respective sub-area of the decision logic is advantageously restricted on the basis of the traffic rules relevant to the environment and/or possible maneuvers of the vehicle. In order to simplify the analysis, parts of the decision logic can be deactivated, insofar as the analysis would always be the same based on the environment and the corresponding analysis would provide the same result.

In a further embodiment of the invention, the respective sub-area of the decision logic is dynamically adapted to the position of the vehicle and/or the environment of the vehicle, in particular, in the event of a change in the position and/or the environment of the vehicle.

It is advantageous to be able to store predefined sub-areas of the decision logic for typical positions of the vehicle in a memory and use them to analyze the respective maneuvering options.

One possible application is an indication of whether a vehicle's automatic parking aid is analyzing whether the vehicle is allowed to park at all or for how long. For this purpose, the parking aid provides the corresponding maneuvering option (e.g. parking on the right) to the analysis unit. The analysis unit is used to analyze the maneuvering option and provides a positive or negative analysis result according to the position and optionally according to the environment of the vehicle. If parking is permitted at the location in accordance with the applicable traffic rules, the parking procedure is carried out—otherwise a warning signal may be provided.

In summary, the invention relates to an analysis unit for a vehicle, a method for analyzing the maneuvering options of a vehicle, and a vehicle comprising such an analysis unit. The analysis unit comprises a decision logic that can be dynamically reduced to a sub-area depending on the position and optionally depending on the environment of the vehicle. The analysis unit, in particular, the decision logic, is used to analyze at least one maneuvering option of a vehicle based on the relevant or valid traffic rules at the respective position. The traffic rules are mapped in the decision logic or its sub-area. Based on the analysis, a maneuvering option can be analyzed for permissibility according to the traffic rules, and the permissibility can be displayed to a driver of the vehicle or to a control unit of an autonomous vehicle.

### BRIEF DESCRIPTION OF THE DRAWINGS

The invention is further described and explained below with reference to the figures. The exemplary embodiments shown in the figures are provided purely by way of example and in no way limit the invention. In the figures:

FIG. 1 illustrates a possibility analysis unit;

FIG. 2 illustrates a vehicle on a roadway; and

FIG. 3 illustrates possible sub-areas of decision logic.

### DETAILED DESCRIPTION OF THE CURRENT EMBODIMENT

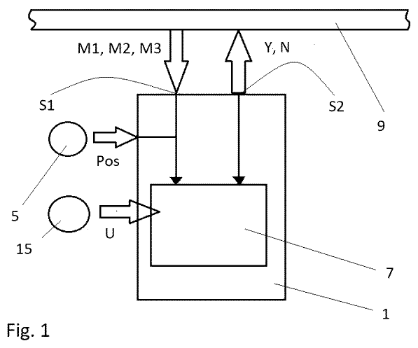

FIG. 1 shows a possible analysis unit 1. The analysis unit 1 comprises a decision logic 7, an input interface S1, and an output interface S2. The input interface S1 is used to record a maneuvering option M1, M2, M3 of a vehicle 3. The output interface S2 is used to provide the analysis result Y, N to a BUS system 9. The input interface S1 and the output interface S2 are connected to the BUS system 9. The BUS system 9 is advantageously the BUS system 9 of a vehicle 3, wherein the BUS system 9 is a technical data connection, for example a CAN BUS.

The position Pos of the vehicle 3 is also provided to the analysis unit 1 by a position sensor 5. The position Pos is also advantageously provided via the BUS system 9.

Optionally, an environment U of the vehicle 3 is provided to the analysis unit 1. The environment U is detected by an environment sensor 15. The environment sensor 15 is advantageously designed as a radar sensor or a camera sensor. The environment U includes the position Pos and optionally the speed of other road users or obstacles for the vehicle 3.

The decision logic 7 is used to obtain analysis B of the maneuvering options M1, M2, M3 provided to it. The analysis B is based on the position Pos of vehicle 3.

Optionally, the analysis B of the respective maneuvering option M1, M2, M3 of the vehicle 3 is based on the environment U of the vehicle 3, wherein the environment U of the vehicle 3 is provided to the decision logic by the environment sensor 15.

The evaluation unit 1 shown here is designed for use in a vehicle 3. Such an analysis unit 1 is advantageously designed as a software module, which is installed on a computing unit (not shown) and can be run there. It is particularly advantageous that at least the decision logic 7 is designed as a software module and installed on a computing unit, where it can be run.

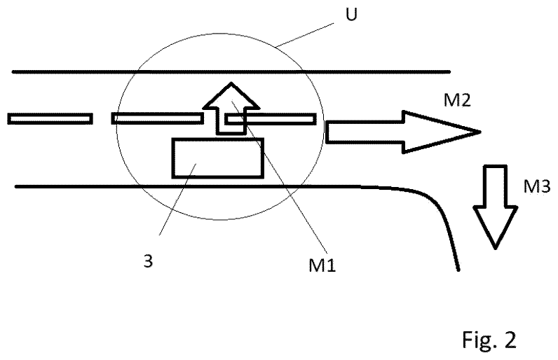

FIG. 2 shows a vehicle 3 on a roadway. The vehicle is shown in the right-hand lane (shown here as the bottom lane). The vehicle 3 can perform at least three maneuvering maneuvers M1, M2, M3.

The first maneuvering option M1 is a lane change of the vehicle 3 to the left (upper) lane. Depending on the position Pos of the vehicle 3, the first maneuvering option M1 can be analyzed as “permitted” (compliant with traffic rules) or “prohibited” (not compliant with traffic rules) in accordance with the traffic regulations.

The second maneuvering option M2 involves driving vehicle 3 straight ahead. Depending on the position Pos of the vehicle 3, the second maneuvering option M2 can be analyzed as “permitted” (compliant with traffic rules, Y) or “prohibited” (not compliant with traffic rules, N) in accordance with the traffic regulations.

The third maneuvering option M3 represents a turn to the right (downward). Depending on the position Pos of the vehicle 3, the third maneuvering option M3 can be analyzed as “permitted” (compliant with traffic rules) or “prohibited” (not compliant with traffic rules) in accordance with the traffic regulations.

The analysis B using the analysis unit 1 produces a positive analysis result Y or a negative analysis result N, depending on the traffic rules applicable at the position Pos of the vehicle 3. The analysis result Y, N is provided to the vehicle 3. The vehicle 3, insofar as it is an autonomous vehicle, can perform the corresponding maneuvering options M1, M2, M3 according to the analysis result Y, N.

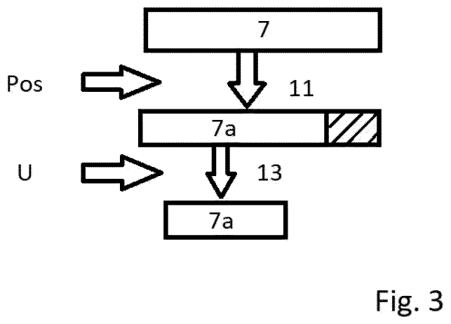

FIG. 3 shows possible sub-areas 7a of a decision logic 7. In a first stage 11, the decision logic 7 is reduced to a sub-area 7a on the basis of the respective position Pos of the vehicle. The shaded area of the decision logic 7 is omitted here. The shaded part of the decision logic 7 corresponds (figuratively speaking) to the part of the traffic rules that do not apply at the respective position Pos of the vehicle 3 (e.g. inner city/position of the vehicle on a highway) and would therefore always lead to a positive evaluation result Y.

In a second stage 13, the sub-area 7a of the decision logic can be reduced based on the environment of the vehicle 3.

Insofar as the vehicle 3 is located on a highway, for example, the decision logic is reduced to the traffic rule for the highway to a first sub-area 7a. Insofar as the environment U of the vehicle 3 has only limited maneuvering options M1, M2, M3, the decision logic can also be restricted accordingly in the second stage 13.

### LIST OF REFERENCE SIGNS

1 analysis unit
3 vehicle
5 position sensor
7 decision logic
7a sub-area (of the decision logic)
9 BUS system
11 first stage
13 second stage
15 environment sensor
Pos position
M1 first maneuvering option
M2 second and third maneuvering option
M3 third maneuvering option
U environment
B analysis
Y, N (positive, negative) analysis result
S1 input interface
S2 output interface

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An analysis unit for use in a vehicle, comprising:
an input interface for a position of the vehicle;
an output interface for an output signal; and
decision logic configured to analyze at least one maneuvering option of the vehicle, wherein the at least one maneuvering option is determined based on a position of the vehicle, wherein the analysis of the at least one maneuvering option is based on the position of the vehicle, and wherein an analysis result is made available as an output signal to a control unit or a BUS system of the vehicle.

2. The analysis unit of claim 1, further including a GPS sensor to provide the position of the vehicle.

3. The analysis unit of claim 1, wherein the decision logic is based on Boolean decision logic.

4. The analysis unit of claim 1, wherein only a sub-area of the decision logic is activated, where a selection of the sub-area is provided on the basis of the position of the vehicle.

5. The analysis unit of claim 4, wherein the selection of the sub-area of the decision logic takes placed in a first stage and in a second stage.

6. The analysis unit of claim 1, wherein a reduced number of maneuvering options for analysis are provided according to the position of the vehicle.

7. The analysis unit of claim 6, wherein the reduced number of maneuvering options is provided based on an environment of the vehicle.

8. The analysis unit of claim 1, wherein:
the analysis of the at least one maneuvering option is provided in real time; or
the analysis result is made available in real time.

9. A vehicle comprising:
a position sensor;
a control unit or a BUS system; and
the analysis unit of claim 1, wherein the position sensor provides the position of the vehicle to the analysis unit, and wherein the analysis unit is configured to analyze a plurality of maneuvering options.

10. A method for analyzing a maneuvering option of a vehicle including the analysis unit of claim 1, the method comprising:
determining a position of the vehicle;
providing the position of the vehicle to the analysis unit;
providing a plurality of maneuvering options based on the position of the vehicle;
analyzing the plurality of maneuvering options; and
providing the analysis result as an output signal, wherein the analysis unit carries out the analysis depending on the position of the vehicle on the basis of a decision logic, wherein the decision logic is based on traffic rules which are valid at the position of the vehicle.

11. The method according to claim 10, wherein:
a reduced number of the plurality of maneuvering options are provided;
the analysis of the plurality of maneuvering options is performed in a sub-area of the decision logic; and
the sub-area of the decision logic is limited to the analysis of the plurality of maneuvering options.

12. The method of claim 10, wherein the analysis is based on a previously determined sub-set of traffic rules, wherein the sub-set of traffic rules is determined based on the position of the vehicle.

13. The method of claim 10, wherein an environment sensor detects the environment of the vehicle, wherein analyzing the plurality of maneuvering options is based on the environment of the vehicle.

14. The method of claim 11, wherein an environment sensor detects the environment of the vehicle, wherein the defined sub-area of the decision logic is determined on the basis of the environment of the vehicle.

15. The method of claim 11, wherein the defined sub-area of the decision logic is dynamically adapted to changes in the position of the vehicle or the environment of the vehicle.

16. A computer program product as part of a vehicle control system, configured to be installed and run on a computing unit, wherein the computer program product is configured to perform the method of claim 10.
